(19) United States
(12) Patent Application Publication
(10) Pub. No.: US 2025/0062853 A1
(43) Pub. Date: Feb. 20, 2025

(54) Machine-Learning-Based Collision Detection for Retransmissions

(71) Applicant: Cisco Technology, Inc., San Jose, CA (US)

(72) Inventors: Jerome Henry, Pittsboro, NC (US); Pascal Thubert, Roquefort les Pins (FR); JP Vasseur, Combloux (FR); Indermeet Gandhi, San Jose, CA (US); Robert Barton, Richmond (CA)

(21) Appl. No.: 18/452,435

(22) Filed: Aug. 18, 2023

Related U.S. Application Data
(60) Provisional application No. 63/501,630, filed on May 11, 2023.

(51) Int. Cl. H04L 1/00; H04B 7/06; H04L 5/00; H04W 24/02

(52) U.S. Cl. CPC H04L 1/0003; H04B 7/0626; H04L 1/0061; H04L 5/0053; H04W 24/02

(57) ABSTRACT

Described herein are devices, systems, methods, and processes for improving retransmissions in wireless communication networks by distinguishing between temporal interference and longer-term radio frequency (RF) condition issues. The fact that the access point (AP) does not usually move may be leveraged, and a machine learning process can be utilized to learn and adapt to the RF conditions in the cell. The AP records various parameters for each frame received from client devices and uses this data to build a pairwise temporal matrix. Machine learning models are trained using these parameters, enabling the AP to compute the likely efficient set of modulation and coding schemes (MCSs) at each static position and along moving positions. The AP can then adapt its MCS accordingly for the downlink traffic and provide the client device with recommended MCSs for upcoming uplink transmissions. Accordingly, the retry count at the client devices can be reduced.

The present disclosure relates to wireless communication. More particularly, the present disclosure relates to improving retransmissions in wireless communication networks by distinguishing between different types of channel condition issues.

### PRIORITY

This application claims the benefit of and priority to U.S. Provisional Application No. 63/501,630, filed May 11, 2023, which is incorporated in its entirety herein.

### BACKGROUND

Some wireless communication networks, such as Wi-Fi, operate on a half-duplex system where transmitters cannot confirm if a frame was successfully received by its intended destination. To address this, unicast frames are acknowledged by the destination. However, when no acknowledgement is received, the transmitter is left uncertain as to why the transmission failed. This may be due to a variety of reasons, including degradation of radio frequency (RF) conditions in the cell or collisions causing transmission failure.

Existing solutions to address transmission failure in wireless communication networks have their limitations. Presently, Minstrel or similar rate control processes are used. Minstrel operates by maintaining a statistical record of the success rates of different transmission rates (corresponding to different modulation and coding schemes (MCSs)). Minstrel periodically tries out less often used rates to explore the performance of these rates. Based on the gathered statistics, Minstrel then selects the rate with the highest throughput for the next packet transmission. Rate shifting algorithms can display a fairly static response, where the transmitter retries a certain number of times at the current rate before shifting down in a pre-determined sequence. The mechanism can be inefficient, especially if the issue is a degradation of RF conditions, where retrying is futile. Moreover, the linear approach to lowering rates can also be inefficient and a waste of resources if the issue is a temporal interference (e.g., a chance collision) that dissipates after a short period.

Furthermore, once a transmitter has shifted down in its rate, most algorithms, usually derived from Minstrel, are conservative on the climb back up, keeping the transmitter at a low rate for an extended period. Such an approach does not take into account the dynamic nature of wireless communication networks, where RF conditions can change rapidly due to various factors. As a result, there is a need for a more adaptive and efficient method to address transmission failure in wireless communication networks.

### SUMMARY OF THE DISCLOSURE

Systems and methods for improving retransmissions in wireless communication networks by distinguishing between different types of channel condition issues in accordance with embodiments of the disclosure are described herein. In some embodiments, a network node, includes a processor, at least one network interface controller configured to provide access to a network, and a memory communicatively coupled to the processor, wherein the memory includes a modulation and coding scheme (MCS) logic. The logic can be configured to receive one or more frames from a client device, identify at least one characteristic associated with the client device based on the received one or more frames, identify one or more recommended MCSs for the client device based on the identified at least one characteristic and a machine learning process, and transmit an indication of the one or more recommended MCSs to the client device.

In some embodiments, the at least one characteristic associated with the client device includes a radio frequency (RF) parameter associated with the client device.

In some embodiments, the RF parameter includes at least one of a received signal strength indicator (RSSI), a signal-to-noise ratio (SNR), or a signal-to-interference-plus-noise ratio (SINR).

In some embodiments, the at least one characteristic associated with the client device includes a device type of the client device.

In some embodiments, the at least one characteristic associated with the client device includes a movement of the client device relative to the network node.

In some embodiments, to identify the one or more recommended MCSs for the client device, the MCS logic is further configured to identify a probability of success associated with each of the one or more recommended MCSs.

In some embodiments, the indication of the one or more recommended MCSs further includes an indication of the probability of success associated with each of the one or more recommended MCSs.

In some embodiments, the machine learning process is associated with a machine learning model, and the machine learning model is trained based on one or more of radio frequency (RF) parameter data, MCS data, retry indicator data, channel state information (CSI) data, noise floor data, acknowledgement (ACK) data, client device type data, or client device movement data.

In some embodiments, the machine learning model includes a linear regression model.

In some embodiments, the MCS logic is further configured to predict that a short-term channel condition between the client device and the network node is unstable, and wherein the indication of the one or more recommended MCSs is transmitted to the client device in response to the prediction that the short-term channel condition between the client device and the network node is unstable.

In some embodiments, the indication of the one or more recommended MCSs is transmitted to the client device via an unsolicited action frame or a modified acknowledgement (ACK) message.

In some embodiments, the short-term channel condition between the client device and the network node is predicted to be unstable based on a non-linear process that compares a current stochasticity of at least one radio frequency (RF) parameter to an expected range.

In some embodiments, the non-linear process is associated with a Lyapunov exponent.

In some embodiments, the MCS logic is further configured to identify a most suitable MCS for the network node in response to the prediction that the short-term channel condition between the client device and the network node is unstable and apply the most suitable MCS at the network node.

In some embodiments, the indication of the one or more recommended MCSs is transmitted to the client device in an association process between the client device and the network node.

In some embodiments, the MCS logic is further configured to identify that a first frame in the one or more frames from the client device is faulty, and wherein the indication of the one or more recommended MCSs is transmitted to the client device in response to the identification that the first frame is faulty.

In some embodiments, the faulty first frame fails a cyclic redundancy check (CRC) but includes a decodable header based on which the client device is identifiable as being a source and the network node is identifiable as being a destination.

In some embodiments, a client device, includes a processor, at least one network interface controller configured to provide access to a network, and a memory communicatively coupled to the processor, wherein the memory includes a modulation and coding scheme (MCS) logic. The logic is configured to transmit at least one frame to a network node, receive an indication of one or more recommended MCSs from the network node, and apply one of the one or more recommended MCSs at the client device.

In some embodiments, the indication of the one or more recommended MCSs further includes an indication of a probability of success associated with each of the one or more recommended MCSs.

In some embodiments, a method for recommending a modulation and coding scheme (MCS) includes receiving one or more frames from a client device, identifying at least one characteristic associated with the client device based on the received one or more frames, identifying one or more recommended MCSs for the client device based on the identified at least one characteristic and a machine learning process, and transmitting an indication of the one or more recommended MCSs to the client device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a diagram illustrating a wireless communication network where embodiments of the disclosure may be practiced in accordance with various embodiments of the disclosure;

FIG. 2 is a diagram illustrating pairwise temporal matrices in accordance with various embodiments of the disclosure;

FIG. 3 is a diagram illustrating a process of providing recommended modulation and coding schemes (MCSs) to a client device in a wireless communication network in accordance with various embodiments of the disclosure;

FIG. 4 is a flowchart showing a process for predicting a probability of success associated with each of one or more MCSs based on collected data in accordance with various embodiments of the disclosure;

FIG. 5 is a flowchart showing a process for identifying recommended MCSs for a client device based on a received frame and a machine learning process in accordance with various embodiments of the disclosure;

FIG. 6 is a flowchart showing a process for managing MCSs in response to unstable channel conditions between a network node and a client device in accordance with various embodiments of the disclosure;

FIG. 7 is a flowchart showing a process for managing MCSs in response to receiving a faulty frame from a client device in accordance with various embodiments of the disclosure;

FIG. 8 is a flowchart showing a process for managing MCSs at a client device in accordance with various embodiments of the disclosure; and

FIG. 9 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that improve retransmissions in wireless communication networks by distinguishing between temporal interference and longer-term radio frequency (RF) condition issues. In many embodiments, the transmitter may switch to the ideal or near-ideal modulation and coding scheme (MCS) (an MCS may correspond to a data rate) without relying on the conventional retry and linear MCS shift mechanisms commonly used in the field. Techniques described herein may leverage the advantage that the access point (AP) does not usually move. Therefore, although the RF conditions in the cell may change, as long as the environment is stable (e.g., no walls are added or removed, no RF interferer is added), the RF conditions may be bounded. Thus, in a number of embodiments, an AP can learn these conditions and utilize the learning to take the most efficient corrective action in the downlink (downstream) and advise the client device on the best corrective action in the uplink (upstream).

In a variety of embodiments, the AP may record various parameters for each frame received from a client device. These parameters can include, but are not limited to, the received signal strength indicator (RSSI), the signal-to-interference-plus-noise ratio (SINR), the signal-to-noise ratio (SNR), the MCS, the retry bit value (a retry bit of a frame may indicate whether the frame is a retry/retransmission), and/or the channel state information (CSI) of the frame. Hereinafter signal strength or quality-related parameters may be referred to as RF parameters. Therefore, RF parameters can include, but are not limited to, the RSSI, the SINR, or the SNR. In some embodiments, when the AP transmits a unicast frame, it can record the MCS used for the transmission, the local noise floor, and may observe the acknowledgement (ACK) from the destination client device. Whether an ACK is received from the destination may be recorded. Further, if an ACK is received, the AP can record the RF parameters (e.g., RSSI, SINR, and/or SNR, etc.) of the ACK frame, the MCS of the ACK frame, and/or the CSI of the ACK frame.

In more embodiments, the AP can build a pairwise temporal matrix for each client device with the recorded elements described above. In particular, a pairwise temporal matrix for a client device may include a list of the uplink and downlink parameters (elements) of the exchanges. In additional embodiments, the AP may group client devices into subgroups based on their movement patterns. By way of non-limiting examples, the subgroups can correspond to client devices that are moving closer to the AP, moving farther away from the AP, or not moving relative to the AP. Although values such as the RSSI, the SINR, and/or the SNR are stochastic in nature, they can form over time a slope whose gradient may indicate whether the client device is moving. The client device movement grouping can be useful because in a given cell, the movement of a client device at particular positions may usually be bounded (e.g., people may tend to position devices on tables or on their laps when sitting, people may move devices between pieces of furniture, etc.). In further embodiments, the AP may group client devices into subgroups based on the client device type. In still more embodiments, the client device groupings may be utilized as features in the training of the machine learning model, which will be described in further detail below.

In still further embodiments, a machine learning model (e.g., a linear regression model) may be trained using the parameters (elements) described above. In still additional embodiments, the AP can compute the likely efficient set of MCSs at each static position utilizing the machine learning model. The AP can also compute the likely efficient set of MCSs at each RF position (e.g., an RF position may correspond to an RF parameter such as the RSSI) for the moving series (e.g., for a moving client device) utilizing the machine learning model. In some more embodiments, the machine learning process can enable the AP to estimate at each static position, the probability of success of each possible MCS (e.g., for uplink and downlink), and, along moving positions, the mapping between the probability of success of each possible MCS and the sliding RF parameter (e.g., RSSI) (the sliding RF parameter may correspond to changing distances between the AP and the client device).

In certain embodiments, when the AP exchanges consecutive frames with a client device, the AP may observe the elements (e.g., the RF parameters, the MCS, the retry bit value, the CSI, the local noise floor, the ACK status, the RF parameters for the ACK frame, the MCS for the ACK frame, and/or the CSI for the ACK frame, etc.), and may perform a prediction on the short-term stability of the channel conditions of the channel between the AP and the client device. In yet more embodiments, the short-term prediction may be based on comparing the current stochasticity of the parameters to their expected range(s). By way of a non-limiting example, a non-linear process (e.g., the Lyapunov exponent (a measure used in dynamical systems theory to quantify the rate of separation of infinitesimally close trajectories)) can be utilized to make the short-term prediction. Of course, in still yet more embodiments, other short-term processes may also be utilized. If the changes are within the expected slope boundaries, the channel conditions can be predicted as being stable, and the AP can continue using its current MCS. If the changes are outside the expected slope boundaries, the channel conditions can be predicted as being unstable (e.g., the channel conditions may be predicted as subject to imminent change, which can be either degradation or improvement), and the AP may immediately adapt its MCS accordingly for the downlink traffic.

In many further embodiments, if the channel conditions are predicted as being unstable, upon successfully receiving a frame from the client device, the AP can send an ACK immediately followed by an unsolicited action frame that provides the recommended MCSs (e.g., the predicted top n set of MCSs) for the client device for upcoming uplink transmissions. In many additional embodiments, the action frame can also provide, for each recommended MCS, the predicted probability of success (e.g., the success prediction confidence). In still yet further embodiments, the action frame can simply provide a list of all possible MCSs and the predicted probability of success associated with each of the possible MCSs. The action frame can also provide the time projection for the confidence values. In still yet additional embodiments, instead of an action frame following the ACK, the AP may also provide the recommended MCSs (possibly together with the success prediction confidence and the associated time projection, as appropriate) via a modified ACK frame.

In several embodiments, the AP may also send the unsolicited action frame providing the recommended MCSs (possibly together with the success prediction confidence and the associated time projection, as appropriate) at the time a client device associates with the AP (i.e., at association). The AP may identify the recommended MCSs based on the position of the client device at association time. By way of a non-limiting example, the AP can send the action frame as part of the association response (or immediately after the association is completed). Therefore, the client device may learn the likely best MCS(s) without having to waste cycles randomly trying MCSs in buckets until a working set is found (the working set may not be optimal and may need to be changed again soon).

In several more embodiments, the AP may receive a frame from a client device, where the header of the frame can be decoded such that the source and destination of the frame can be ascertained, but the cyclic redundancy check (CRC) for the frame fails. In response to receiving such a faulty frame, the AP can provide the recommended MCSs for the client device for the current observed conditions (e.g., via an action frame or a modified negative ACK (NACK) to the client device). The recommended MCSs may help the client device decide whether it simply needs to retry (e.g., in case the failure was due to a temporal event, e.g., a collision, unrelated to degraded longer-term RF conditions) or it needs to rate shift (and to what MCS) (e.g., in case the failure was due to degraded RF conditions). In numerous embodiments, the AP may use a reinforcement learning technique to modify the parameters of the machine learning model and optimize the model's response based on a target of minimizing the retry count at the client devices. Accordingly, an AP may predict if a transmission failure is caused by a temporal collision or a longer-term RF issue.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

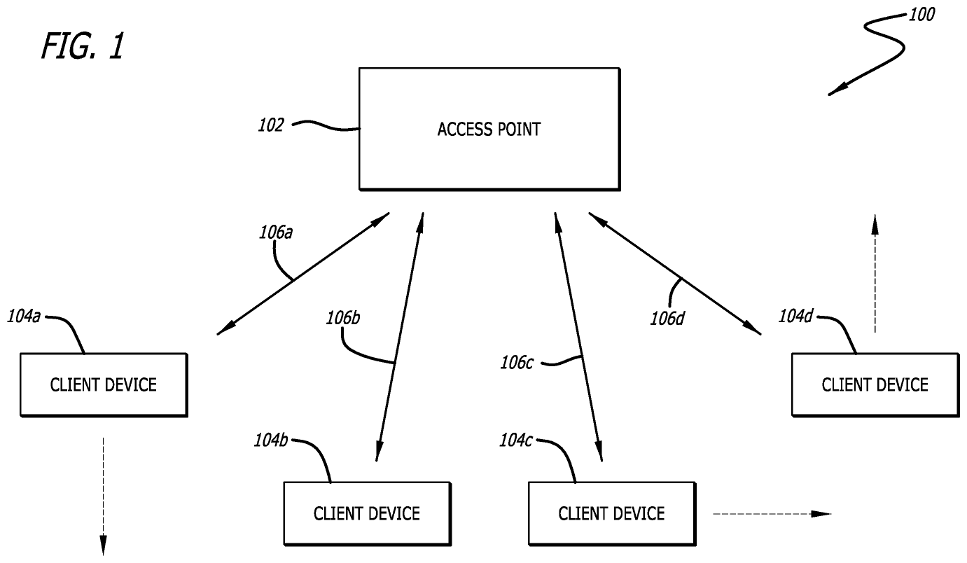

Referring to FIG. 1, a diagram illustrating a wireless communication network 100 where embodiments of the disclosure may be practiced in accordance with various embodiments of the disclosure is shown. The AP 102 may be in communication with four client devices 104a, 104b, 104c, and 104d. The wireless communication between the AP 102 and each of the client devices can be represented by communication links 106a, 106b, 106c, and 106d, respectively. In many embodiments, the client device 104a may be moving away from the AP 102. The movement may lead to a change in the RF conditions (e.g., a degradation) due to the increased distance, which can affect the efficiency of the communication link 106a. As a result, the AP 102 and/or the client device 104 may need to adapt their MCSs to maintain effective communication. In a number of embodiments, the client device 104b can be stationary, i.e., not moving relative to the AP 102. This, in general, can suggest stable RF conditions for the communication link 106b. Stable RF conditions can be advantageous for maintaining a consistent data rate. However, even in such stable conditions, the AP 102 may still need to monitor the RF parameters to ensure optimal performance.

In a variety of embodiments, the client device 104c, while in motion, may maintain a relatively constant distance from the AP 102. In different scenarios (e.g., depending on if and where there are other objects between the AP 102 and the client device 104c), the RF conditions between the AP 102 and client device 104c for the communication link 106c may or may not remain relatively stable. In some embodiments, the client device 104d may be moving closer to the AP 102. This movement may, under certain circumstances, lead to improved RF conditions for the communication link 106d due to the reduced distance. In such a scenario, the AP 102 and/or the client device 104c can leverage the improvement to increase the data rate, enhancing the efficiency of the network.

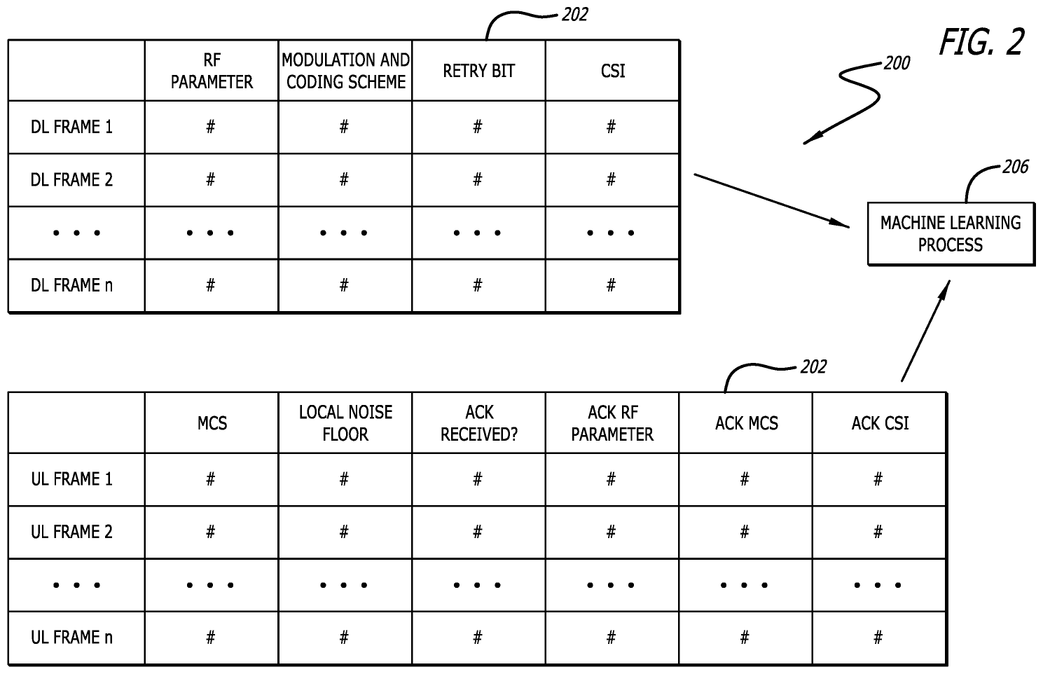

Although a specific embodiment for a wireless communication network suitable for carrying out the various steps, processes, methods, and operations described herein is discussed with respect to FIG. 1, any of a variety of systems and/or processes may be utilized in accordance with embodiments of the disclosure. For example, the AP can be equipped with machine learning capabilities to predict the optimal MCS based on the recorded RF parameters and movement patterns of the client devices. The elements depicted in FIG. 1 may also be interchangeable with other elements of FIGS. 2-9 as required to realize a particularly desired embodiment.

Referring to FIG. 2, a diagram 200 illustrating pairwise temporal matrices in accordance with various embodiments of the disclosure is shown. In many embodiments, a pairwise temporal matrix 202 (or simply “matrix 202) may be associated with downlink (DL) frames received by the AP from a client device. For each of the DL frames (e.g., numbered from 1 to n), the matrix 202 can record the RF parameter (e.g., the RSSI, the SINR, and/or the SNR), the MCS, the retry bit (which may indicate whether the frame is a retransmission/retry), and the CSI. In a number of embodiments, another pairwise temporal matrix 204 (or simply “matrix 204”) may be associated with uplink (UL) frames transmitted by the AP to the client device. For each of the UL frames (e.g., numbered from 1 to n), the matrix 204 can record the MCS, the local noise floor, and whether an ACK is received by the AP for the frame. In case an ACK is received, the matrix 204 further records the RF parameter (e.g., the RSSI, the SINR, and/or the SNR) for the ACK frame, the MCS for the ACK frame, and the CSI for the ACK frame.

In a variety of embodiments, there can also be other matrices corresponding to frames transmitted between the AP and other client devices. Each of these matrices can record similar parameters for the DL and UL frames associated with the respective client devices. In some embodiments, all the pairwise temporal matrices, including the matrix 202 and the matrix 204, may be utilized to train a machine learning model in a machine learning process 206. In more embodiments, the machine learning model can be a linear regression model. In additional embodiments, the trained model can then be used to predict the optimal MCS(s) for future communications. In particular, in further embodiments, the machine learning model can be utilized to compute the likely efficient set of MCSs at each static position and each RF position (e.g., an RF position may correspond to an RF parameter such as the RSSI) for the moving series (e.g., for a moving client device).

Although a specific embodiment for pairwise temporal matrices suitable for carrying out the various steps, processes, methods, and operations described herein is discussed with respect to FIG. 2, any of a variety of systems and/or processes may be utilized in accordance with embodiments of the disclosure. For example, the matrices can be dynamically updated in real-time as new frames are transmitted and received, allowing the machine learning model to adapt to changing network conditions. The elements depicted in FIG. 2 may also be interchangeable with other elements of FIGS. 1 and 3-9 as required to realize a particularly desired embodiment.

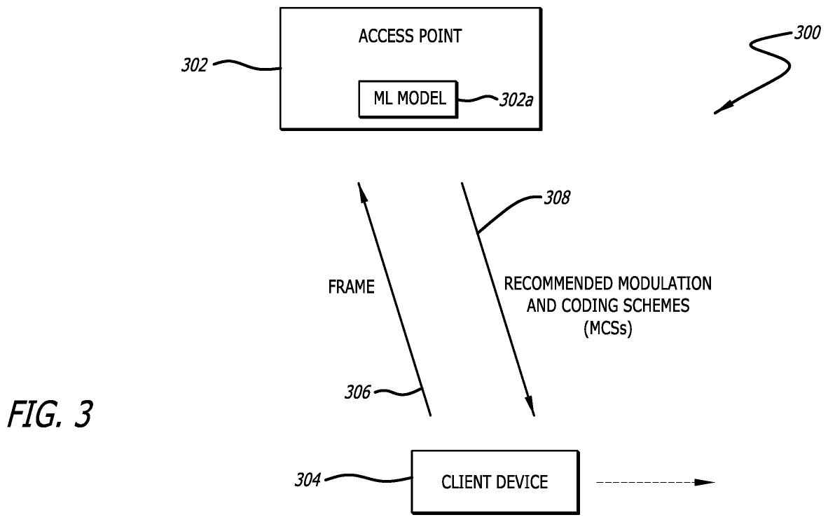

Referring to FIG. 3, a diagram 300 illustrating a process of providing recommended MCSs to a client device in a wireless communication network in accordance with various embodiments of the disclosure is shown. The recommended MCSs may help improve retransmissions in wireless communication networks. In many embodiments, the client device 304 can transmit at least one frame 306 to the AP 302. In a number of embodiments, if the client device 304 is moving (e.g., as shown in the embodiment depicted in FIG. 3), the movement of the client device 304 can affect the RF conditions and thus the efficiency of the communication between the AP 302 and the client device 304. The at least one frame 306 transmitted by the client device 304 (in particular, the RF parameter associated with the at least one frame 306) can provide the AP 302 with data about the current RF conditions. In a variety of embodiments, the AP 302 may use the machine learning model 302a (which may be trained as described above) to analyze the received at least one frame 306 (and possibly other relevant parameters). Based on the analysis, the machine learning model 302a can predict the likely efficient set of MCSs for the client device 304 for the current conditions. In some embodiments, the machine learning model 302a can also be utilized to predict a probability of success (and possibly a time projection as well) associated with each of the likely efficient set of MCSs for the client device 304.

In more embodiments, the AP 302 may perform a prediction on the short-term stability of the channel conditions of the channel between the AP 302 and the client device 304. In additional embodiments, the short-term prediction may be based on comparing the current stochasticity of the parameters (e.g., the RF parameters, the MCS, the CSI, etc.) to their expected range(s). By way of a non-limiting example, a non-linear process (e.g., the Lyapunov exponent) can be utilized to make the short-term prediction. In further embodiments, other short-term processes may also be utilized. If the changes are within the expected slope boundaries, the channel conditions can be predicted as being stable, and the AP 302 can continue using its current MCS. If the changes are outside the expected slope boundaries, the channel conditions can be predicted as being unstable (e.g., the channel conditions may be predicted as subject to imminent change, which can be either degradation or improvement), and the AP 302 may immediately adapt its MCS accordingly for the downlink traffic to the client device 304.

In still more embodiments, if the channel conditions are predicted as being unstable, upon successfully receiving a frame (e.g., a frame subsequent to the at least one frame 306) from the client device 304, the AP 302 can send an ACK immediately followed by an unsolicited action frame that provides the recommended MCSs 308 (e.g., the predicted top n set of MCSs) for the client device 304 for upcoming uplink transmissions. In still further embodiments, the action frame can also provide, for each recommended MCS, the predicted probability of success. In still additional embodiments, the action frame can simply provide a list of all possible MCSs and the predicted probability of success associated with each of the possible MCSs. The action frame can also provide the time projection for the confidence values. In some more embodiments, instead of an action frame following the ACK, the AP 302 may also provide the recommended MCSs 308 (possibly together with the success prediction confidence and the associated time projection, as appropriate) via a modified ACK frame.

In certain embodiments, the AP 302 may also send the unsolicited action frame providing the recommended MCSs 308 (possibly together with the success prediction confidence and the associated time projection, as appropriate) at the time the client device 304 associates with the AP 302 (i.e., at association). The AP 302 may identify the recommended MCSs 308 based on the position of the client device 304 at association time. By way of a non-limiting example, the AP 302 can send the action frame as part of the association response (or immediately after the association is completed). Therefore, the client device 304 may learn the likely best MCS(s) without having to waste cycles randomly trying MCSs in buckets until a working set is found (the working set may not be optimal and may need to be changed again soon).

In yet more embodiments, the AP 302 may receive a frame from a client device (e.g., subsequent to the at least one frame 306), where the header of the frame can be decoded such that the source and destination of the frame can be ascertained, but the cyclic redundancy check (CRC) for the frame fails. In response to receiving such a faulty frame, the AP 302 can provide the recommended MCSs 308 for the client device 304 for the current observed conditions (e.g., via an action frame or a modified negative ACK (NACK) to the client device 304). The recommended MCSs 308 may help the client device 304 decide whether it simply needs to retry (e.g., in case the failure was due to a temporal event, e.g., a collision, unrelated to degraded longer-term RF conditions) or it needs to rate shift (and to what MCS) (e.g., in case the failure was due to degraded RF conditions).

Although a specific embodiment for providing recommended MCSs to a client device suitable for carrying out the various steps, processes, methods, and operations described herein is discussed with respect to FIG. 3, any of a variety of systems and/or processes may be utilized in accordance with embodiments of the disclosure. For example, the AP can use the machine learning model to generate a list of recommended MCSs, which can be dynamically updated based on the changing RF conditions and the performance of the client device. The elements depicted in FIG. 3 may also be interchangeable with other elements of FIGS. 1, 2, and 4-9 as required to realize a particularly desired embodiment.

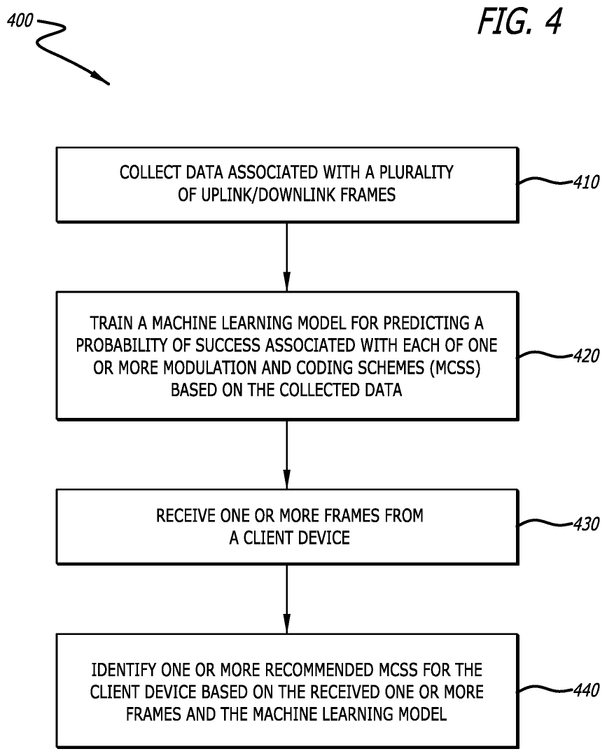

Referring to FIG. 4, a flowchart showing a process 400 for predicting a probability of success associated with each of one or more MCSs based on collected data in accordance with various embodiments of the disclosure is shown. In many embodiments, the process 400 may collect data associated with a plurality of uplink and/or downlink frames (block 410). The data can include various parameters such as, but not limited to, the RF parameters, the MCS, the CSI, the ACK status, the type of client device, the movement of the client device, and/or the performance of the frames. In a number of embodiments, the data may be recorded in pairwise temporal matrices.

In a variety of embodiments, the process 400 may train a machine learning model for predicting a probability of success associated with each of one or more MCSs based on the collected data (block 420). The machine learning model can use the collected data to learn the relationship between the various parameters and the success of the MCSs. The trained model can then predict the probability of success of each MCS under different conditions. In some embodiments, the machine learning model may be a linear regression model.

In more embodiments, the process 400 may receive one or more frames from a client device (block 430). These frames can provide real-time data about the current conditions and performance of the client device. The process 400 can use the data to identify the most suitable MCSs for the client device.

In additional embodiments, the process 400 may identify one or more recommended MCSs for the client device based on the received one or more frames and the machine learning model (block 440). The recommended MCSs can be those that the machine learning model predicts to have the highest probability of success under the current conditions. The process 400 can then transmit an indication of these recommended MCSs to the client device.

Although a specific embodiment for predicting a probability of success associated with each of one or more MCSs based on collected data suitable for carrying out the various steps, processes, methods, and operations described herein is discussed with respect to FIG. 4, any of a variety of systems and/or processes may be utilized in accordance with embodiments of the disclosure. For instance, the process can be implemented in a network node, such as an AP, to dynamically adjust the MCS based on the changing conditions and performance of each client device. The elements depicted in FIG. 4 may also be interchangeable with other elements of FIGS. 1-3 and 5-9 as required to realize a particularly desired embodiment.

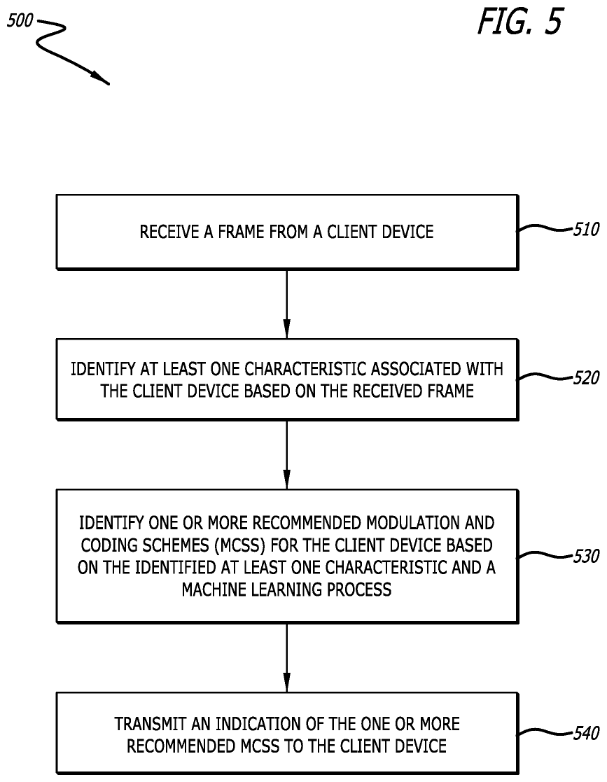

Referring to FIG. 5, a flowchart showing a process 500 for identifying recommended MCSs for a client device based on a received frame and a machine learning process in accordance with various embodiments of the disclosure is shown. In many embodiments, the process 500 may receive a frame from a client device (block 510). The frame can be associated with various types of data, such as, but not limited to, the RF parameter, the MCS, and/or the CSI. The frame received from the client device can be processed and decoded by the network node to extract the relevant data for further analysis and decision-making in the subsequent operations.

In a number of embodiments, the process 500 may identify at least one characteristic associated with the client device based on the received frame (block 520). The characteristic can include parameters such as, but not limited to, the client device type, the movement of the client device relative to the network node, or the RF parameters associated with the client device. The identification of the characteristic associated with the client device can involve the use of processes that analyze the received frame and extract the relevant parameters or features that define the characteristic.

In a variety of embodiments, the process 500 may identify one or more recommended MCSs for the client device based on the identified at least one characteristic and a machine learning process (block 530). The machine learning process can use the identified characteristic to predict the most efficient MCSs for the client device under the current conditions. In some embodiments, the machine learning process may be associated with a linear regression model.

In more embodiments, the process 500 may transmit an indication of the one or more recommended MCSs to the client device (block 540). In additional embodiments, the transmission of the indication of the one or more recommended MCSs to the client device can be carried out via an unsolicited action frame or a modified ACK message. The client device can then use this indication to adjust its MCS for upcoming transmissions.

Although a specific embodiment for identifying recommended MCSs for a client device based on a received frame and a machine learning process suitable for carrying out the various steps, processes, methods, and operations described herein is discussed with respect to FIG. 5, any of a variety of systems and/or processes may be utilized in accordance with embodiments of the disclosure. For example, the machine learning model may be continuously updated as new frames are received, allowing the model to adapt to changing network conditions and client device performance. The elements depicted in FIG. 5 may also be interchangeable with other elements of FIGS. 1-4 and 6-9 as required to realize a particularly desired embodiment.

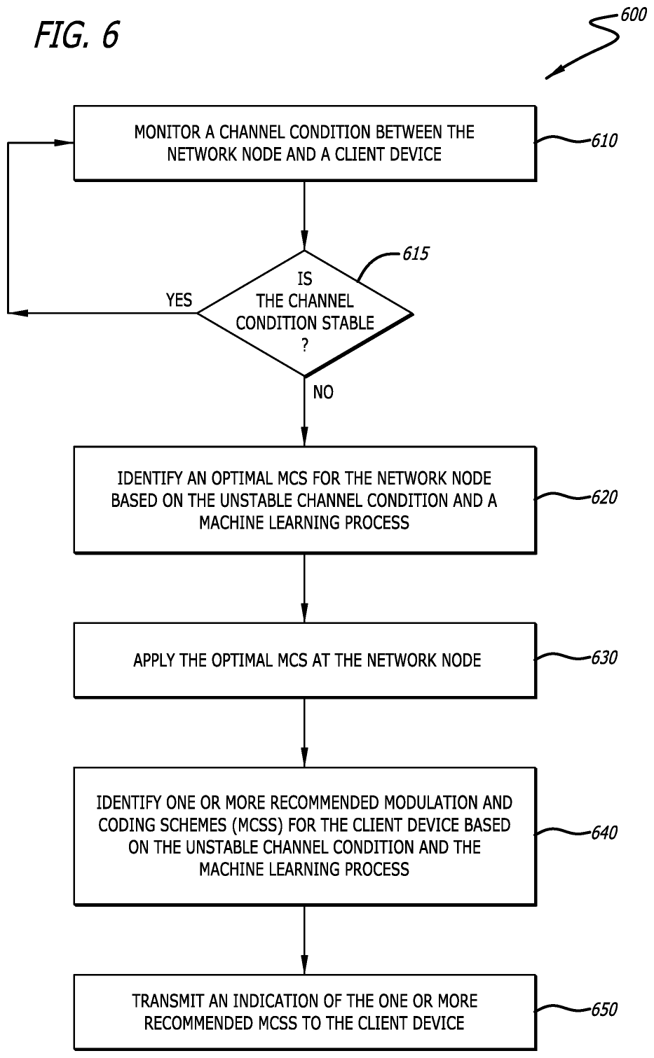

Referring to FIG. 6, a flowchart showing a process 600 for managing MCSs in response to unstable channel conditions between a network node and a client device in accordance with various embodiments of the disclosure is shown. In many embodiments, the process 600 may monitor a channel condition between the network node and a client device (block 610). The monitoring can involve the collection and analysis of various parameters such as, but not limited to, the signal strength, noise level, and/or interference level on the channel. The monitoring can be performed continuously or at specific intervals, and the data collected can be stored in a structured format for efficient processing by the machine learning model.

In a number of embodiments, the process 600 can determine if the channel condition is stable (block 615). In a variety of embodiments, if the channel condition is stable, the process 600 can continue monitoring the channel condition. On the other hand, in some embodiments, in response to the channel condition being unstable, the process 600 can identify an optimal MCS for the network node based on the unstable channel condition and a machine learning process.

In more embodiments, in response to the channel condition being unstable, the process 600 can identify an optimal MCS for the network node based on the unstable channel condition and a machine learning process (block 620). The machine learning process can use the monitored channel condition and other relevant parameters to predict the most efficient MCS for the network node under the current conditions. The most efficient MCS for the network node may have the highest predicted performance under the current conditions.

In additional embodiments, the process 600 can apply the optimal MCS at the network node (block 630). The application of the optimal MCS can involve adjusting the modulation and coding parameters of the network node to match the optimal MCS. In particular, the application of the optimal MCS at the network node can involve adjusting the modulation type, coding rate, and other transmission parameters of the network node to match the settings defined by the optimal MCS.

In further embodiments, the process 600 can identify one or more recommended MCSs for the client device based on the unstable channel condition and the machine learning process (block 640). The recommended MCSs may be those that the machine learning process predicts to have the highest probability of success under the current conditions. In still more embodiments, the capabilities and limitations of the client device, such as, but not limited to, its supported MCSs and performance history can also be considered when the recommended MCSs are being identified.

In still further embodiments, the process 600 can transmit an indication of the one or more recommended MCSs to the client device (block 650). In still additional embodiments, the transmission of the indication of the one or more recommended MCSs to the client device can be carried out via an unsolicited action frame or a modified ACK message. The client device can then use the indication to adjust its MCS for upcoming transmissions.

Although a specific embodiment for managing MCSs in response to unstable channel conditions between a network node and a client device suitable for carrying out the various steps, processes, methods, and operations described herein is discussed with respect to FIG. 6, any of a variety of systems and/or processes may be utilized in accordance with embodiments of the disclosure. For example, the machine learning model can not only be used to predict the optimal MCS for the network node but also to identify recommended MCSs for the client device. The elements depicted in FIG. 6 may also be interchangeable with other elements of FIGS. 1-5 and 7-9 as required to realize a particularly desired embodiment.

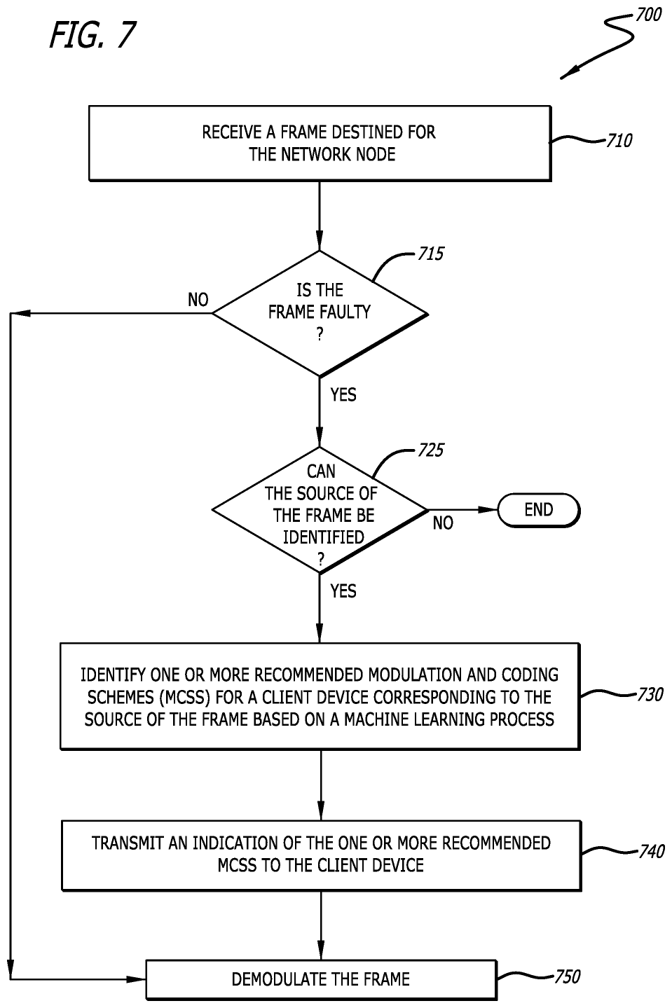

Referring to FIG. 7, a flowchart showing a process 700 for managing MCSs in response to receiving a faulty frame from a client device in accordance with various embodiments of the disclosure is shown. In many embodiments, the process 700 may receive a frame destined for the network node (block 710). The frame can be associated with various types of data, such as, but not limited to, the RF parameter, the MCS, and/or the CSI. The frame can be processed and at least partially decoded by the network node to extract the relevant data, even though the frame may be faulty.

In a number of embodiments, the process 700 can determine if the received frame is faulty (block 715). In a variety of embodiments, if the frame is not faulty, the process 700 can proceed to demodulate the frame. On the other hand, in some embodiments, in response to the frame being faulty, the process 700 can determine if the source of the frame can be identified.

In more embodiments, in response to the frame being faulty, the process 700 can determine if the source of the frame can be identified (block 725). If the source of the frame cannot be identified, the process 700 can end. On the other hand, in additional embodiments, if the source of the frame can be identified, the process 700 can identify one or more recommended MCSs for a client device corresponding to the source of the frame based on a machine learning process.

In further embodiments, if the source of the frame can be identified, the process 700 can identify one or more recommended MCSs for a client device corresponding to the source of the frame based on a machine learning process (block 730). In still more embodiments, the source of the frame can be identified based on a decodable header (in particular, a transmitter address (TA) field of the header) of the frame. The machine learning process can use the data associated with the faulty frame and other relevant parameters to predict the most efficient MCSs for the client device under the current conditions.

In still further embodiments, the process 700 can transmit an indication of the one or more recommended MCSs to the client device (block 740). In still additional embodiments, the transmission of the indication of the one or more recommended MCSs to the client device can be carried out via an unsolicited action frame or a modified NACK message. The client device can then use this indication to adjust its MCS for upcoming transmissions.

Although a specific embodiment for managing MCSs in response to receiving a faulty frame from a client device suitable for carrying out the various steps, processes, methods, and operations described herein is discussed with respect to FIG. 7, any of a variety of systems and/or processes may be utilized in accordance with embodiments of the disclosure. For example, the machine learning model may be used to predict the optimal MCSs for the client device even when the frame as received by the AP is faulty, as long as the source of the frame can be identified. The elements depicted in FIG. 7 may also be interchangeable with other elements of FIGS. 1-6, 8, and 9 as required to realize a particularly desired embodiment.

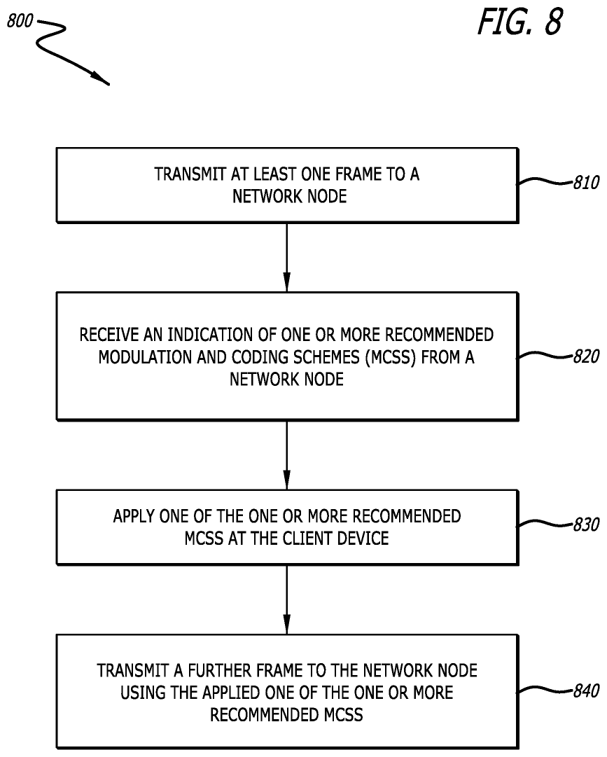

Referring to FIG. 8, a flowchart showing a process 800 for managing MCSs at a client device in accordance with various embodiments of the disclosure is shown. In many embodiments, the process 800 may transmit at least one frame to a network node (block 810). The frame can be associated with various types of data, such as, but not limited to, the RF parameter, the MCS, and/or the CSI. The frame can be processed and at least partially decoded by the network node to extract the relevant data.

In a number of embodiments, the process 800 may receive an indication of one or more recommended MCSs from a network node (block 820). The indication can be based on the analysis of the at least one frame and a machine learning process. In a variety of embodiments, the indication of the one or more recommended MCSs to the client device can be received via an unsolicited action frame or a modified NACK message. In some embodiments, the indication can suggest the most efficient MCSs for the client device under the current conditions. In more embodiments, the indication of the one or more recommended MCSs may further include an indication of a probability of success associated with each of the one or more recommended MCSs.

In additional embodiments, the process 800 may apply one of the one or more recommended MCSs at the client device (block 830). The application of the one of the recommended MCSs can involve adjusting the modulation and coding parameters of the client device to match the settings defined by the recommended MCS. In particular, the application of the one of the recommended MCSs at the client device can involve adjusting the modulation type, coding rate, and other transmission parameters of the client device to match the settings defined by the recommended MCS.

In further embodiments, the process 800 may transmit a further frame to the network node using the applied one of the one or more recommended MCSs (block 840). The further frame can be used by the network node to assess the effectiveness of the recommended MCS and to update its machine learning model, as appropriate. The transmission of the further frame can involve encoding and modulating the data according to the applied MCS, and then transmitting the resulting frame over the wireless channel to the network node.

Although a specific embodiment for managing MCSs at a client device suitable for carrying out the various steps, processes, methods, and operations described herein is discussed with respect to FIG. 8, any of a variety of systems and/or processes may be utilized in accordance with embodiments of the disclosure. For example, the process can be implemented in a client device that dynamically adjusts its MCS based on the recommendations received from the network node. The elements depicted in FIG. 8 may also be interchangeable with other elements of FIGS. 1-7 and 9 as required to realize a particularly desired embodiment.

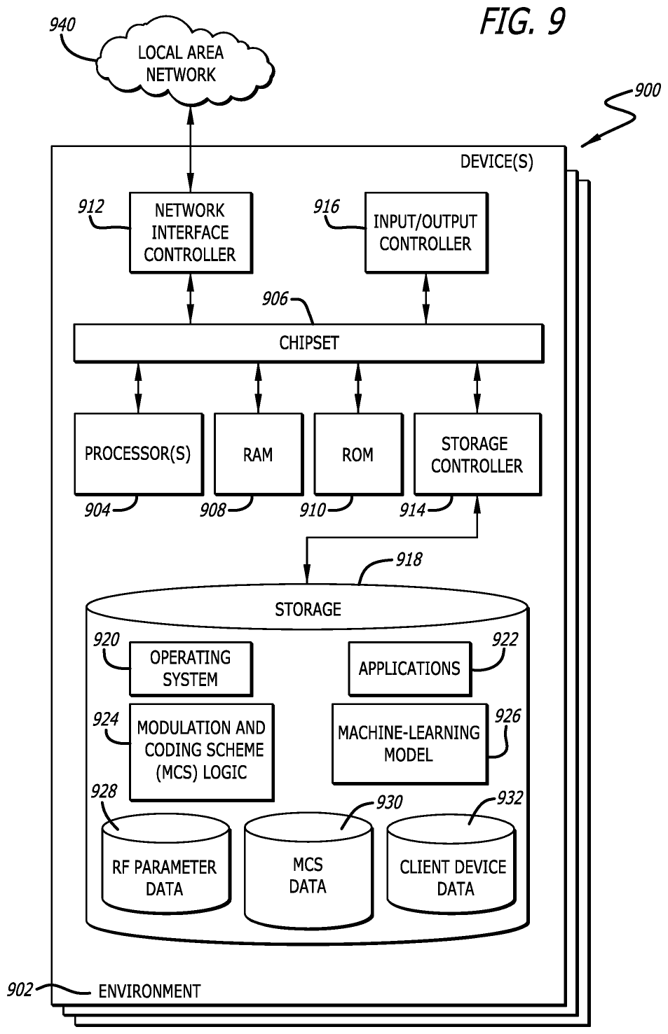

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the computer device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, RF parameter data 928, MCS data 930, and client device data 932, which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more computer devices 900 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiment, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the computer device 900. In some examples, the virtualization layer may be supported by a hypervisor that provides one or more virtual machines running on the computer device 900 to perform functions described herein. The virtualization layer may generally support a virtual resource that performs at least a portion of the techniques described herein.

In many embodiments, the device 900 can include a MCS logic 924. The MCS logic 924 can be used to determine the optimal MCS for data transmission based on various factors such as channel conditions, device capabilities, and network performance. It can utilize machine learning processes to predict the most efficient MCS under different conditions.

In a number of embodiments, the storage 918 can include RF parameter data 928. The RF parameter data 928 can include parameters such as, but not limited to, signal strength, RSSI, noise level, interference level, SNR, and/or SINR. The RF parameter data 928 may be utilized to assess the quality of the wireless channel and to determine the optimal MCS.

In various embodiments, the storage 918 can include MCS data 930. The MCS data 930 can include data about the current MCS, the history of MCS changes, and the performance of different MCSs under various conditions. The MCS data 930 can be utilized to train a machine learning model for predicting the optimal MCS.

In still more embodiments, the storage 918 can include client device data 932. The client device data 932 can include data such as, but not limited to, the type of client devices, the capabilities of client devices, the movement of client devices relative to the AP, and performance history of client devices. The client device data 932 can be utilized to tailor the MCS recommendations to the specific conditions of each client device.

Finally, in many embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to predict the optimal MCSs for each client device under different conditions.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network node, comprising:
a processor;
at least one network interface controller configured to provide access to a network; and
a memory communicatively coupled to the processor, wherein the memory comprises a modulation and coding scheme (MCS) logic that is configured to:
receive one or more frames from a client device;
identify at least one characteristic associated with the client device based on the received one or more frames;
identify one or more recommended MCSs for the client device based on the identified at least one characteristic and a machine learning process; and
transmit an indication of the one or more recommended MCSs to the client device.

2. The network node of claim 1, wherein the at least one characteristic associated with the client device includes a radio frequency (RF) parameter associated with the client device.

3. The network node of claim 2, wherein the RF parameter includes at least one of a received signal strength indicator (RSSI), a signal-to-noise ratio (SNR), or a signal-to-interference-plus-noise ratio (SINR).

4. The network node of claim 1, wherein the at least one characteristic associated with the client device includes a device type of the client device.

5. The network node of claim 1, wherein the at least one characteristic associated with the client device includes a movement of the client device relative to the network node.

6. The network node of claim 1, wherein to identify the one or more recommended MCSs for the client device, the MCS logic is further configured to identify a probability of success associated with each of the one or more recommended MCSs.

7. The network node of claim 6, wherein the indication of the one or more recommended MCSs further includes an indication of the probability of success associated with each of the one or more recommended MCSs.

8. The network node of claim 1, wherein the machine learning process is associated with a machine learning model, and the machine learning model is trained based on one or more of radio frequency (RF) parameter data, MCS data, retry indicator data, channel state information (CSI) data, noise floor data, acknowledgement (ACK) data, client device type data, or client device movement data.

9. The network node of claim 8, wherein the machine learning model includes a linear regression model.

10. The network node of claim 1, wherein the MCS logic is further configured to predict that a short-term channel condition between the client device and the network node is unstable, and wherein the indication of the one or more recommended MCSs is transmitted to the client device in response to the prediction that the short-term channel condition between the client device and the network node is unstable.

11. The network node of claim 10, wherein the indication of the one or more recommended MCSs is transmitted to the client device via an unsolicited action frame or a modified acknowledgement (ACK) message.

12. The network node of claim 10, wherein the short-term channel condition between the client device and the network node is predicted to be unstable based on a non-linear process that compares a current stochasticity of at least one radio frequency (RF) parameter to an expected range.

13. The network node of claim 12, wherein the non-linear process is associated with a Lyapunov exponent.

14. The network node of claim 10, wherein the MCS logic is further configured to:
identify a most suitable MCS for the network node in response to the prediction that the short-term channel condition between the client device and the network node is unstable; and
apply the most suitable MCS at the network node.

15. The network node of claim 1, wherein the indication of the one or more recommended MCSs is transmitted to the client device in an association process between the client device and the network node.

16. The network node of claim 1, wherein the MCS logic is further configured to generate an identification that a first frame in the one or more frames from the client device is faulty, and wherein the indication of the one or more recommended MCSs is transmitted to the client device in response to the identification that the first frame is faulty.

17. The network node of claim 16, wherein the faulty first frame fails a cyclic redundancy check (CRC) but includes a decodable header based on which the client device is identifiable as being a source and the network node is identifiable as being a destination.

18. A client device, comprising:
a processor;
at least one network interface controller configured to provide access to a network; and
a memory communicatively coupled to the processor, wherein the memory comprises a modulation and coding scheme (MCS) logic that is configured to:
transmit at least one frame to a network node;
receive an indication of one or more recommended MCSs from the network node; and
apply one of the one or more recommended MCSs at the client device.

19. The client device of claim 18, wherein the indication of the one or more recommended MCSs further includes an indication of a probability of success associated with each of the one or more recommended MCSs.

20. A method for recommending a modulation and coding scheme (MCS), comprising:
receiving one or more frames from a client device;
identifying at least one characteristic associated with the client device based on the received one or more frames;
identifying one or more recommended MCSs for the client device based on the identified at least one characteristic and a machine learning process; and
transmitting an indication of the one or more recommended MCSs to the client device.
